(19) United States
(12) Patent Application Publication
(10) Pub. No.: US 2026/0037289 A1
(43) Pub. Date: Feb. 5, 2026

(54) ENABLING LARGE FRAMES FOR SECURE VIRTUAL MACHINES

(71) Applicant: INTERNATIONAL BUSINESS MACHINES CORPORATION, Armonk, NY (US)

(72) Inventors: Claudio IMBRENDA, Boeblingen (DE); Fadi Y. BUSABA, Poughkeepsie, NY (US); Christian BORNTRAEGER, Stuttgart (DE); Lisa Cranton HELLER, Rhinebeck, NY (US); Jonathan D. BRADBURY, Poughkeepsie, NY (US); Torsten HENDEL, Holzgerlingen (DE)

(21) Appl. No.: 18/791,934

(22) Filed: Aug. 1, 2024

(51) Int. Cl. G06F 9/455; G06F 21/57

(52) U.S. Cl. CPC G06F 9/45545; G06F 21/57

(57) ABSTRACT

The computer-implemented methods, computer program products, and computer systems include computer operations that include executing, in a trusted computing environment, a call from a host in an untrusted computing environment, where the call is to determine a status of a large page of memory for use by a secure guest, where the secure guest is managed by the host in the untrusted computing environment. The executing includes determining that all small pages comprising the large page and the large page meet pre-defined security requirements. The executing also includes, based on the determining, setting security properties of the large page and the small pages comprising the large page to enable translation for the large page for a given block of memory of the secure guest. The executing also includes storing in a computing element, a designation identifying the large page as belonging to the secure guest.

### BACKGROUND

One or more aspects relate, in general, to facilitating processing within a computing environment, and in particular, to improving such processing.

Cloud computing and cloud storage provides users with capabilities to store and process their data in third-party data centers. Cloud computing facilitates the ability to provision a virtual machine (VM) for a customer quickly and easily, without requiring the customer to purchase hardware or to provide floor space for a physical server. The customer may easily expand or contract the VM according to changing preferences or requirements of the customer. Typically, a cloud computing provider provisions the VM, which is physically resident on a server at the provider's data center. Customers are often concerned about the security of data in the VM, particularly since computing providers often store more than one customer's data on the same server. Customers may desire security between their own code/data and the cloud computing provider's code/data, as well as between their own code/data and that of other VMs running at the provider's site. In addition, the customer may desire security from the provider's administrators as well as against potential security breaches from other code running on the machine.

To handle such sensitive situations, cloud service providers may implement security controls to ensure proper data isolation and logical storage segregation. The extensive use of virtualization in implementing cloud infrastructure results in unique security concerns for customers of cloud services as virtualization alters the relationship between an operating system (OS) and the underlying hardware, be it computing, storage, or even networking hardware. This introduces virtualization as an additional layer that itself must be properly configured, managed and secured.

In general, a VM, running as a guest under the control of a host hypervisor, relies on that hypervisor to transparently provide virtualization services for that guest. These services include memory management, instruction emulation, and interruption processing. For example, guest memory can be paged out by the host at any time.

In the case of memory management, the VM can move (page-in) its data from a disk to be resident in memory and the VM can also move its data back out (page-out) to the disk. While the page is resident in memory, the VM (guest) uses dynamic address translation (DAT) to map the pages in memory from a guest virtual address to a guest absolute address. In addition, the host hypervisor has its own DAT mapping (from host virtual address to host absolute address) for the guest pages in memory and it can, independently and transparently to the guest, page the guest pages in and out of memory. It is through the host DAT tables that the hypervisor provides memory isolation or sharing of guest memory between two separate guest VMs. The host is also able to access the guest memory to simulate guest operations, when necessary, on behalf of the guest.

A hypervisor or virtual machine manager can control various guests (e.g., virtual machines, virtual servers) with access to system resources. Different guests managed by a common hypervisor can be generated by different owners. Of these guests, some can be secure guests. A traditional hypervisor has full control over all guests hosted. In particular, the hypervisor has the capability to inspect and even modify all memory of the hosted guest. In a cloud environment such a setup requires the hypervisor and its administrators to be fully trustworthy.

A secure guest, which can also be referred to as a secure execution guest) is a guest that can be hosted by hypervisors that are not (fully) trustworthy. The image of such a guest would be protected when loaded and the protection of the contents of the resources assigned to the guest (e.g., memory, CPU registers) would be maintained throughout the lifetime of the guest. The protection of the guest comprises at least integrity protection (e.g., hypervisor cannot maliciously change any guest states) and in addition can comprise maintaining the confidentiality of the initial image and code and data running in the guest. These services can apply to any interface between a secure entity and another untrusted entity that traditionally allows access to the secure resources by this other entity.

### SUMMARY

Shortcomings of the prior art are overcome, and additional advantages are provided through the provision of a computer program product. The computer program product includes a set of one or more computer-readable storage media and program instructions, collectively stored in the set of one or more computer-readable storage media, for causing at least one computing device to perform computer operations. The computer operations include executing, in a trusted computing environment, a call from a host in an untrusted computing environment, where the call is to determine a status of a large page of memory for use by a secure guest, where the secure guest is managed by the host in the untrusted computing environment. The executing includes determining that all small pages comprising the large page and the large page meet pre-defined security requirements. The executing also includes, based on the determining, setting security properties of the large page and the small pages comprising the large page to enable translation for the large page for a given block of memory of the secure guest. The executing also includes storing in a computing element, a designation identifying the large page as belonging to the secure guest.

Shortcomings of the prior art are overcome, and additional advantages are provided through the provision of a computer-implemented method. The method includes executing, in a trusted computing environment, a call from a host in an untrusted computing environment, wherein the call is to determine a status of a large page of memory for use by a secure guest, wherein the secure guest is managed by the host in the untrusted computing environment. The executing includes determining that all small pages comprising the large page and the large page meet pre-defined security requirements. The executing also includes, based on the determining, setting security properties of the large page and the small pages comprising the large page to enable translation for the large page for a given block of memory of the secure guest. The executing also includes storing in a computing element, a designation identifying the large page as belonging to the secure guest.

Shortcomings of the prior art are overcome, and additional advantages are provided through the provision of a system. The system includes: a memory, one or more processors in communication with the memory, and program instructions executable by the one or more processors via the memory to perform a method. The method includes executing, in a trusted computing environment, a call from a host in an untrusted computing environment, wherein the call is to determine a status of a large page of memory for use by a secure guest, wherein the secure guest is managed by the host in the untrusted computing environment. The executing includes determining that all small pages comprising the large page and the large page meet pre-defined security requirements. The executing also includes, based on the determining, setting security properties of the large page and the small pages comprising the large page to enable translation for the large page for a given block of memory of the secure guest. The executing also includes storing in a computing element, a designation identifying the large page as belonging to the secure guest.

Computer-implemented methods, computer systems and computer program products relating to one or more aspects are described and claimed herein. Each of the embodiments of the computer program product may be embodiments of each computer system and/or each computer-implemented method and vice-versa. Further, each of the embodiments is separable and optional from one another. Moreover, embodiments may be combined with one another. Each of the embodiments of the computer program product may be combinable with aspects and/or embodiments of each computer system and/or computer-implemented method, and vice-versa. Further, services relating to one or more aspects are also described and may be claimed herein.

Additional features and advantages are realized through the techniques described herein. Other embodiments and aspects are described in detail herein and are considered a part of the claimed aspects.

### BRIEF DESCRIPTION OF THE DRAWINGS

One or more aspects are particularly pointed out and distinctly claimed as examples in the claims at the conclusion of the specification. The foregoing and objects, features, and advantages of one or more aspects are apparent from the following detailed description taken in conjunction with the accompanying drawings in which:

FIG. 1 depicts one example of a computing environment to incorporate and use one or more aspects of the present disclosure;

FIG. 2 depicts one example of further details of a processor of the processor set of FIG. 1, in accordance with one or more aspects of the present disclosure;

FIG. 3 depicts one example of a computing environment to incorporate and use one or more aspects of the present disclosure;

FIG. 4 depicts certain components of a computing environment to incorporate and use one or more aspects of the present disclosure;

FIG. 5 is a technical environment that can include various aspects of some embodiments of the present disclosure;

FIG. 6 depicts a workflow comprising various aspects in accordance with one or more aspects of the present disclosure;

FIG. 7 depicts a workflow comprising various aspects in accordance with one or more aspects of the present disclosure;

FIG. 8 depicts a workflow comprising various aspects in accordance with one or more aspects of the present disclosure;

FIG. 9 depicts a table that can be utilized by one or more aspects of the present disclosure;

FIG. 10 depicts a workflow comprising various aspects in accordance with one or more aspects of the present disclosure;

FIG. 11 depicts a workflow comprising various aspects in accordance with one or more aspects of the present disclosure;

FIG. 12 depicts a workflow comprising various aspects in accordance with one or more aspects of the present disclosure; and

FIGS. 13A-13B depict another example of a computing environment to incorporate and use one or more aspects of the present disclosure.

### DETAILED DESCRIPTION

In various computing architectures, secure (execution) guests (e.g., virtual machines (VMs)) can be managed by a hypervisor or host that is not trusted. Secure execution enables a (secure) guest to execute without being accessible to the host. Although the host cannot look into secure guests, the host can page memory to both secure and non-secure guests at any time. Because the host is not trusted, the various security properties associated with the secure guests (and secure execution) are enforced by a security interface control, which can comprise both code and hardware components and can comprise, in some examples an Ultravisor (UV). The code components can be millicode, which is internal code that can be utilized to implements functions in a computing system (e.g., a high level microcode utilized to implement an instruction set in a machine). Because of the complexity of managing secure guests, as opposed to non-secure guests, in existing virtual machine management approaches, page sizes allocated by the host to the secure guests were limited. In one environment, which is provided for illustrative purposes and non-limiting, secure guests could only be backed by small (e.g., 4k) pages in the host. Meanwhile, non-secure guests could be allotted both small pages as well as large pages. The host could allot large pages to non-secure guests (while allotting small pages to both secure and non-secure guests) because the complexities associated with managing secure guests based on allotting pages with an untrusted entity introduced potential processing delays and could impact the general performance of the computing system. Rather than navigate these delays, in some computing environments, existing approaches prevent secure guests from being backed by large pages. An attempt by a requestor to call a hypervisor to back a secure guest with a large page would cause the hardware and/or millicode of the security interface control to return an exception to the source of the call. Because of the implementation concerns (e.g., security and performance), certain benefits of utilizing larger pages could not be realized with existing approaches. For example, larger pages allow for more efficient and faster address translation, promote fewer cache misses, and reduce system overhead (when compared to smaller pages).

One way in which some computing systems validate secure guest memory is by utilizing a table. This table can include host virtual to absolute mappings. Mappings can be contiguous in memory and indexed in this table by host absolute address. An example of a computing system that utilizes a table in this manner is the z/Architecture instruction set architecture that is described in a publication entitled, “z/Architecture Principles of Operation,” IBM Publication No. SA22-7832-13, Fourteenth Edition, May 2022, which is hereby incorporated herein by reference in its entirety. The z/Architecture instruction set architecture, however, is only one example architecture; other architectures and/or other types of computing environments of International Business Machines Corporation and/or of other entities may include and/or use one or more aspects of the present invention. z/Architecture and IBM are trademarks or registered trademarks of International Business Machines Corporation in at least one jurisdiction. This architecture example utilizes a table referred to as a secure execution identifier (SEID) table (also referred to as SEIDT). The use of this table, or an architecture that includes a table, in its current configuration, for this type of mapping, can create performance losses based on a loss of locality. For example, when two adjacent guest pages are mapped to two distinct host pages (potentially far away from each other), each access yields two distinct table accesses. Accessing distant entries can lead to cache misses because when accessing two blocks next to each other, whether a guest is secure of not, there is regular access overhead, but with the secure guest there is additional overhead because one accesses table entries to guarantee the security properties. Hence, in the examples herein, certain conditions are created in advance such that secure guests can be backed with larger pages but because these conditions are satisfied in advance of backing the secure guest with the larger page, the potential additional overhead cost is minimized.

Disclosed herein are computer program products that include a set of one or more computer-readable storage media. The computer program products include program instructions, collectively stored in the set of one or more computer-readable storage media, for causing at least one computing device to perform computer operations. In some examples, these operations include executing, in a trusted computing environment, a call from a host in an untrusted computing environment, wherein the call is to determine a status of a large page of memory for use by a secure guest, wherein the secure guest is managed by the host in the untrusted computing environment. The executing includes determining that all small pages comprising the large page and the large page meet pre-defined security requirements. The executing includes based on the determining, setting security properties of the large page and the small pages comprising the large page to enable translation for the large page for a given block of memory of the secure guest. The executing includes storing in a computing element, a designation identifying the large page as belonging to the secure guest. These examples enable the computing environment to realize the processing advantages provided by backing guests with large pages whether or not the guest is a secure guest or a non-secure guest. Larger page sizes allow for more efficient and faster address translation and this functionality had formerly been limited to non-secure guests.

Alternatively or additionally, the secure guest comprises a virtual machine. The use of virtual machines in a computing environment diversifies the processing capabilities of the computing system.

Alternatively or additionally, the host comprises a hypervisor. A hypervisor can apportion absolute memory to virtual machines, allowing the environment to utilize its resources efficiently. Meanwhile, the hypervisor maintains the security of secure guests operating in the environment.

Alternatively or additionally, the computing element is selected from the group consisting of: a bitmap and a table. A computer program product can utilize a bit map or a table value as an approach, with minimal impact to overhead, to enable a secure interface control to provide a response to a host regarding whether a large page can be utilized to back a secure guest, increasing the processing speed of the computing system.

Alternatively or additionally, the translation for the large page for the given block of memory of the secure guest is performed by hardware in trusted computing environment. Utilizing hardware in a trusted environment to perform this translation maintains the security of the trusted environment while still allowing the host to allocate large page to secure guests, when appropriate.

Alternatively or additionally, the computer operations include determining that all small pages comprising the large page and the large page meet pre-defined security requirements. These requirements are that for each page of the small pages and the large page: the computer operations determine that a page index field of a virtual address matches a page index field of a corresponding absolute address. The computer operations determine that the page is secure. The computer operations include determining that the page has the same guest owner as all other pages of the small pages and the large page. The computer operations determine that an absolute address of the page is located within a common large page in absolute memory. Previous allocation approaches did not enable a host to back a secure guest with large pages because of the overhead and processing load involved in determining if a page can be allocated. This approach checks certain properties in advance so that the processing efficiencies of the computing system are not negatively impacted by enabling backing of secure guests with large pages.

Alternatively or additionally, the computer operations can include receiving a request from the host to back the secure guest with the large page. The computer operations can also include providing the host with access to the large page. By allowing a host to access the large page, the host can allocate the large page to a guest and accomplish the processing advantages of allocating large pages, including performing faster address translation.

Alternatively or additionally, the executing is performed by a secure interface control in the trusted computing environment. The secure interface control is trusted and the security of the secure guest is maintained because the secure interface control clears a page for use by an untrusted host to back a secure guest.

Alternatively or additionally, the computer operations can include obtaining a request from the host to export a small page of the small pages comprising the large page. The computer operations can include determining that the host has permission to perform the export, wherein based on the export, the security properties are re-set to disallow translation for the large page. Secure guests in these examples can be backed by small pages as well as by large pages (provided the conditions are met and the processes described herein are performed) but if there is a change to the properties of a large page or any of the pages that comprise the large page, the system can flexibly adjust such that the host will no longer back a secure guest with a large page as doing so would potentially negatively impact processing efficiencies. Various aspects, such as this one, allow either the host and/or the secure control interface to break a large page so it can no longer be used to back a secure host (because it no longer meets the defined criteria).

Alternatively or additionally, the computer operations can include obtaining a request from the host to export a small page of the small pages comprising the large page. The computer operations can also include based on determining that the host does not have permission to perform the export, generating an error. When there is a change to the properties of a large page or any of the pages that comprises the large page, the system can flexibly adjust such that the host will no longer back a secure guest with a large page as doing so would potentially negatively impact processing efficiencies. Because the host is not trusted, a system can be configured to not allow the frames to be broken by the host, to enhance the security of the system.

Alternatively or additionally, the computer operations can include executing, in the trusted computing environment, another call from the host. The executing can include re-setting the security properties to disallow translation for the large page. When there is a change to the properties of a large page or any of the pages that comprises the large page, the system can flexibly adjust such that the host will no longer back a secure guest with a large page as doing so would potentially negatively impact processing efficiencies. Because the host is not trusted, a system can be configured to not allow the frames to be broken by the host, to enhance the security of the system but instead to allow the secure interface control to perform this functionality as a security measure.

Alternatively or additionally, the secure interface control can comprise elements selected from the group consisting of: millicode and firmware. Implementing a change in millicode or firmware encourages continued system compatibility with the software, including the host.

Alternatively or additionally, the computer operations can include receiving a request from the host to back the secure guest with the large page. The computer operations can include providing the host with access to a small page comprising the large page. Business and processing continuity is maintained in the computer system because a secure guests, just like a non-secure guests, can be backed with either a large page or a small page, depending on conditions discussed herein.

Disclosed herein are computer-implemented method that include requesting execution of an instruction to perform an action defined by the instruction. In some examples, executing the instructions include executing, in a trusted computing environment, a call from a host in an untrusted computing environment, wherein the call is to determine a status of a large page of memory for use by a secure guest, wherein the secure guest is managed by the host in the untrusted computing environment. The executing includes determining that all small pages comprising the large page and the large page meet pre-defined security requirements. The executing includes based on the determining, setting security properties of the large page and the small pages comprising the large page to enable translation for the large page for a given block of memory of the secure guest. The executing includes storing in a computing element, a designation identifying the large page as belonging to the secure guest. These examples enable the computing environment to realize the processing advantages provided by backing guests with large pages whether or not the guest is a secure guest or a non-secure guest. Larger page sizes allow for more efficient and faster address translation and this functionality had formerly been limited to non-secure guests.

Alternatively or additionally, the secure guest comprises a virtual machine. The use of virtual machines in a computing environment diversifies the processing capabilities of the computing system.

Alternatively or additionally, the host comprises a hypervisor. A hypervisor can apportion absolute memory to virtual machines, allowing the environment to utilize its resources efficiently. Meanwhile, the hypervisor maintains the security of secure guests operating in the environment.

Alternatively or additionally, the computing element is selected from the group consisting of: a bitmap and a table. A computer program product can utilize a bit map or a table value as an approach, with minimal impact to overhead, to enable a secure interface control to provide a response to a host regarding whether a large page can be utilized to back a secure guest, increasing the processing speed of the computing system.

Alternatively or additionally, the translation for the large page for the given block of memory of the secure guest is performed by hardware in trusted computing environment. Utilizing hardware in a trusted environment to perform this translation maintains the security of the trusted environment while still allowing the host to allocate large page to secure guests, when appropriate.

Alternatively or additionally, the method can include determining that all small pages comprising the large page and the large page meet pre-defined security requirements. These requirements are that for each page of the small pages and the large page: the method determines that a page index field of a virtual address matches a page index field of a corresponding absolute address. The method determines that the page is secure. The method includes determining that the page has the same guest owner as all other pages of the small pages and the large page. The method determines that an absolute address of the page is located within a common large page in absolute memory. Previous allocation approaches did not enable a host to back a secure guest with large pages because of the overhead and processing load involved in determining if a page can be allocated. This approach checks certain properties in advance so that the processing efficiencies of the computing system are not negatively impacted by enabling backing of secure guests with large pages.

Alternatively or additionally, the method can include receiving a request from the host to back the secure guest with the large page. The method can also include providing the host with access to the large page. By allowing a host to access the large page, the host can allocate the large page to a guest and accomplish the processing advantages of allocating large pages, including performing faster address translation.

Alternatively or additionally, the executing is performed by a secure interface control in the trusted computing environment. The secure interface control is trusted and the security of the secure guest is maintained because the secure interface control clears a page for use by an untrusted host to back a secure guest.

Alternatively or additionally, the method can include obtaining a request from the host to export a small page of the small pages comprising the large page. The method can include determining that the host has permission to perform the export, wherein based on the export, the security properties are re-set to disallow translation for the large page. Secure guests in these examples can be backed by small pages as well as by large pages (provided the conditions are met and the processes described herein are performed) but if there is a change to the properties of a large page or any of the pages that comprise the large page, the system can flexibly adjust such that the host will no longer back a secure guest with a large page as doing so would potentially negatively impact processing efficiencies. Various aspects, such as this one, allow either the host and/or the secure control interface to break a large page so it can no longer be used to back a secure host (because it no longer meets the defined criteria).

Alternatively or additionally, the method can include obtaining a request from the host to export a small page of the small pages comprising the large page. The method can also include based on determining that the host does not have permission to perform the export, generating an error. When there is a change to the properties of a large page or any of the pages that comprises the large page, the system can flexibly adjust such that the host will no longer back a secure guest with a large page as doing so would potentially negatively impact processing efficiencies. Because the host is not trusted, a system can be configured to not allow the frames to be broken by the host, to enhance the security of the system.

Alternatively or additionally, the method can include executing, in the trusted computing environment, another call from the host. The executing can include re-setting the security properties to disallow translation for the large page. When there is a change to the properties of a large page or any of the pages that comprises the large page, the system can flexibly adjust such that the host will no longer back a secure guest with a large page as doing so would potentially negatively impact processing efficiencies. Because the host is not trusted, a system can be configured to not allow the frames to be broken by the host, to enhance the security of the system but instead to allow the secure interface control to perform this functionality as a security measure.

Alternatively or additionally, the secure interface control can comprise elements selected from the group consisting of: millicode and firmware. Implementing a change in millicode or firmware encourages continued system compatibility with the software, including the host.

Alternatively or additionally, the method can include receiving a request from the host to back the secure guest with the large page. The method can include providing the host with access to a small page comprising the large page. Business and processing continuity is maintained in the computer system because a secure guests, just like a non-secure guests, can be backed with either a large page or a small page, depending on conditions discussed herein.

Disclosed herein are computer systems that include at least one computing device. The systems include a set of one or more computer-readable storage media. The computer system include program instructions, collectively stored in the set of one or more computer-readable storage media, for causing the at least one computing device to perform computer operations. In some examples, these operations include executing, in a trusted computing environment, a call from a host in an untrusted computing environment, wherein the call is to determine a status of a large page of memory for use by a secure guest, wherein the secure guest is managed by the host in the untrusted computing environment. The executing includes determining that all small pages comprising the large page and the large page meet pre-defined security requirements. The executing includes based on the determining, setting security properties of the large page and the small pages comprising the large page to enable translation for the large page for a given block of memory of the secure guest. The executing includes storing in a computing element, a designation identifying the large page as belonging to the secure guest. These examples enable the computing environment to realize the processing advantages provided by backing guests with large pages whether or not the guest is a secure guest or a non-secure guest. Larger page sizes allow for more efficient and faster address translation and this functionality had formerly been limited to non-secure guests.

Alternatively or additionally, the secure guest comprises a virtual machine. The use of virtual machines in a computing environment diversifies the processing capabilities of the computing system.

Alternatively or additionally, the host comprises a hypervisor. A hypervisor can apportion absolute memory to virtual machines, allowing the environment to utilize its resources efficiently. Meanwhile, the hypervisor maintains the security of secure guests operating in the environment.

Alternatively or additionally, the computing element is selected from the group consisting of: a bitmap and a table. A computer program product can utilize a bit map or a table value as an approach, with minimal impact to overhead, to enable a secure interface control to provide a response to a host regarding whether a large page can be utilized to back a secure guest, increasing the processing speed of the computing system.

Alternatively or additionally, the translation for the large page for the given block of memory of the secure guest is performed by hardware in trusted computing environment. Utilizing hardware in a trusted environment to perform this translation maintains the security of the trusted environment while still allowing the host to allocate large page to secure guests, when appropriate.

Alternatively or additionally, the computer operations include determining that all small pages comprising the large page and the large page meet pre-defined security requirements. These requirements are that for each page of the small pages and the large page: the computer operations determine that a page index field of a virtual address matches a page index field of a corresponding absolute address. The computer operations determine that the page is secure. The computer operations include determining that the page has the same guest owner as all other pages of the small pages and the large page. The computer operations determine that an absolute address of the page is located within a common large page in absolute memory. Previous allocation approaches did not enable a host to back a secure guest with large pages because of the overhead and processing load involved in determining if a page can be allocated. This approach checks certain properties in advance so that the processing efficiencies of the computing system are not negatively impacted by enabling backing of secure guests with large pages.

Alternatively or additionally, the computer operations can include receiving a request from the host to back the secure guest with the large page. The computer operations can also include providing the host with access to the large page. By allowing a host to access the large page, the host can allocate the large page to a guest and accomplish the processing advantages of allocating large pages, including performing faster address translation.

Alternatively or additionally, the executing is performed by a secure interface control in the trusted computing environment. The secure interface control is trusted and the security of the secure guest is maintained because the secure interface control clears a page for use by an untrusted host to back a secure guest.

Alternatively or additionally, the computer operations can include obtaining a request from the host to export a small page of the small pages comprising the large page. The computer operations can include determining that the host has permission to perform the export, wherein based on the export, the security properties are re-set to disallow translation for the large page. Secure guests in these examples can be backed by small pages as well as by large pages (provided the conditions are met and the processes described herein are performed) but if there is a change to the properties of a large page or any of the pages that comprise the large page, the system can flexibly adjust such that the host will no longer back a secure guest with a large page as doing so would potentially negatively impact processing efficiencies. Various aspects, such as this one, allow either the host and/or the secure control interface to break a large page so it can no longer be used to back a secure host (because it no longer meets the defined criteria).

Alternatively or additionally, the computer operations can include obtaining a request from the host to export a small page of the small pages comprising the large page. The computer operations can also include based on determining that the host does not have permission to perform the export, generating an error. When there is a change to the properties of a large page or any of the pages that comprises the large page, the system can flexibly adjust such that the host will no longer back a secure guest with a large page as doing so would potentially negatively impact processing efficiencies. Because the host is not trusted, a system can be configured to not allow the frames to be broken by the host, to enhance the security of the system.

Alternatively or additionally, the computer operations can include executing, in the trusted computing environment, another call from the host. The executing can include re-setting the security properties to disallow translation for the large page. When there is a change to the properties of a large page or any of the pages that comprises the large page, the system can flexibly adjust such that the host will no longer back a secure guest with a large page as doing so would potentially negatively impact processing efficiencies. Because the host is not trusted, a system can be configured to not allow the frames to be broken by the host, to enhance the security of the system but instead to allow the secure interface control to perform this functionality as a security measure.

Alternatively or additionally, the secure interface control can comprise elements selected from the group consisting of: millicode and firmware. Implementing a change in millicode or firmware encourages continued system compatibility with the software, including the host.

Alternatively or additionally, the computer operations can include receiving a request from the host to back the secure guest with the large page. The computer operations can include providing the host with access to a small page comprising the large page. Business and processing continuity is maintained in the computer system because a secure guests, just like a non-secure guests, can be backed with either a large page or a small page, depending on conditions discussed herein.

In the examples herein, to enable secure guests to be backed with larger pages, elements of the computing architecture are modified. These elements include: 1) introducing a new interface between the host (hypervisor) and the firmware and/or hardware of the secure interface control; and/or 2) modifying a secure guest mapping table to include a bit that indicates that a secure guest can be backed with a larger page and/or frame. In some examples herein, a 1M bit is used as an example of a large frame, however, this non-limiting example is provided for illustrative purposes only as memory pages and/or frames smaller or larger than 1M can be utilized to back secure guests when implementing aspects of the examples herein. Thus, 1M is provided merely to suggest a possibility and not to provide any limitation. A large frame just means that it is larger than a small frame and hence, a large frame is comprised of smaller frames. By implementing a new interface and/or the mapping change in the architecture, a machine will allow backing guest memory with host large pages once the machine registers that the host to guest mapping is available for use (e.g., has met various conditions and the availability can be memorialized including in a table entry). In the examples herein, the interface is a call issued by the hypervisor (host) and executed by a secure interface control (e.g., UV), the former of which is untrusted but the latter of which is trusted. By successfully executing the call, the secure interface control sets the machine in a state that enables small (e.g., 4k) and large (e.g., 1M and/or smaller or larger) host translation for a given large (e.g., 1M and/or smaller or larger) guest page. In certain examples herein, the 1M value is utilized to represent a large page or frame but in other implementations, as aforementioned, the large frame and/or page can be smaller than this size or can exceed this size. The size of a large page can be pre-configured by an administrator in various computing systems into which the aspects of the examples herein can be implemented.

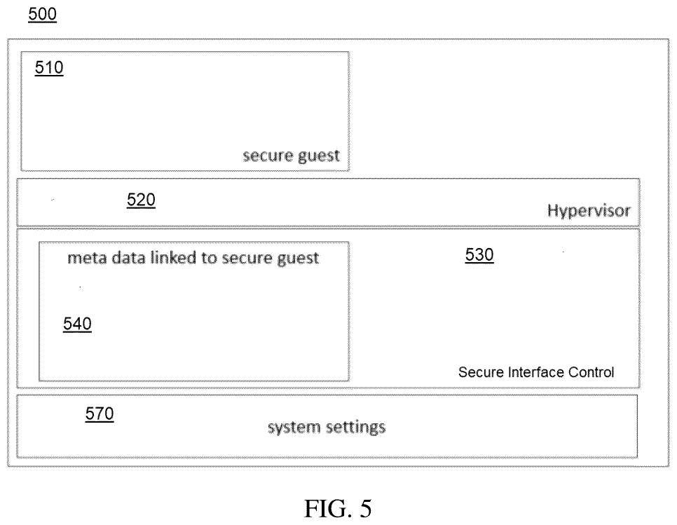

The computer-implemented methods, computer program products, and computer systems described herein facilitate more efficient processing within a computing environment by enabling a host (including an untrusted host, a VM manager such as a hypervisor, etc.) to back secure guests (secure VMs), with large frames or pages. Although a block of central storage is sometimes referred to as a frame and a block of virtual storage sometimes referred to as a page, these terms can sometimes be used interchangeably to designate blocks of memory and they are used interchangeably herein. As described in greater detail herein, enabling the backing of secure guests with large pages can be accomplished by introducing additional hardware and/or UV features, hence, modifying a secure interface control (e.g., FIG. 5, 530) in a computing environment.

As will be discussed in greater detail herein, in certain of the examples herein, a secure interface control in a computing environment can obtain a request from a requestor (e.g., a host or hypervisor) to verify a status of a large page and/or frame of memory of a secure guest. The secure interface control (e.g., trusted firmware and/or a UV (millicode)) can check that all pages belonging to a secure domain of the guest are registered as secure. To check whether the pages belonging to the secure domain are registered as secure, the secure interface control can check that a page index field of a virtual address matches with a page index field of a corresponding absolute address. The secure interface control can also check that the absolute address of the page lies within the same large page and/or frame in absolute memory. The secure interface control can also check that each small page and/or frame (that makes up the large frame or page) is secure and that the small pages and/or frames belong to the same secure guest (e.g., secure VM). Provided that the secure interface control verifies this status (the check produces a favorable result), the secure interface control sets properties of pages evaluated to allow large page and/or frame translation by hardware for the requested large page and/or frame for a specified block of memory of the secure guest. The secure interface control can store data indicating that the large page and/or frame is identified as a secure large page and/or frame of the secure guest in an address translation table. Although there can be other requirements for a host to back a secure guest with a given large page, provided that other conditions (e.g., system requirements, etc.) are met, the secure interface control can provide the requestor (e.g., the host or hypervisor) access to the large page and/or frame based of the page being registered as secure and the large page and/or frame being registered as belonging to the secure domain of the secure guest.

The examples here also include computer-implemented methods, computer program products, and computer systems to break the large frames that were previously allotted for backing secure such that the large host from cannot be utilized to back a large guest frame of a secure guest. This process can be referred to as breaking the frame. To break the frame, in some examples, the requestor (e.g., the host or hypervisor) can issue a request to the secure interface control to export a small page and/or frame belonging to a verified large page and/or frame. When this occurs, the secure interface control can enable the requestor to change the security properties of the small pages and/or frames. Changing of the security properties disallows large page and/or frame translations of the verified large page and/or frame. However, in some examples, the secure interface control does not enable the requestor to change these properties. In this case, upon receiving a call from a requestor (e.g., the host) to break the large frame that the secure interface control created responsive to receiving an initial request, the trusted firmware of the secure interface control can change the security properties of a small page and/or frame belonging to a verified large page and/or frame (as these settings in this example are not accessible to the requestor).

The examples herein are inextricably tied to computing and are directed to a practical application. Backing VM with memory and executing secure and non-secure VMs is a functionality that exists only within a computing environment. Furthermore, the practical application addressed herein is enabling the use of large frames for secure guests in a manner that lessens negative impacts on processing (cache misses, processing speed, overhead, etc.) while taking advantage of this functionality within the limitations of secure execution. The approach disclosed herein utilizes a combination of hardware and software including providing a new interface as well as restructuring a table or other element referenced by hardware of a secure interface control in the computing environment. Thus, the examples disclosed herein are inextricably tied to computing at least because they are directed to a practical application of addressing as issue unique to computing environments with an approach that utilizes aspects of the computing environment.

The examples herein provide significantly more than other approaches. As aforementioned, in some systems, backing secure guests with large pages is not permitted because of negative impacts on processing, efficiency, and overhead. The examples discussed herein provide the desired functionality without these adverse impacts.

Computer-implemented methods, computer systems and computer program products relating to one or more aspects are described and claimed herein. Each of the embodiments of the computer program product may be embodiments of each computer system and/or each computer-implemented method and vice-versa. Further, each of the embodiments is separable and optional from one another. Moreover, embodiments may be combined with one another. Each of the embodiments of the computer program product may be combinable with aspects and/or embodiments of each computer system and/or computer-implemented method, and vice-versa.

One or more aspects of the present disclosure are incorporated in, performed and/or used by a computing environment. As examples, the computing environment may be of various architectures and of various types, including, but not limited to: personal computing, client-server, distributed, virtual, emulated, partitioned, non-partitioned, cloud-based, quantum, grid, time-sharing, cluster, peer-to-peer, wearable, mobile, having one node or multiple nodes, having one processor or multiple processors, and/or any other type of environment and/or configuration, etc. that is capable of executing a process (or multiple processes) that performs control mode processing including selective control mode processing and/or one or more other aspects of the present disclosure. Aspects of the present disclosure are not limited to a particular architecture or environment.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer-readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer-readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

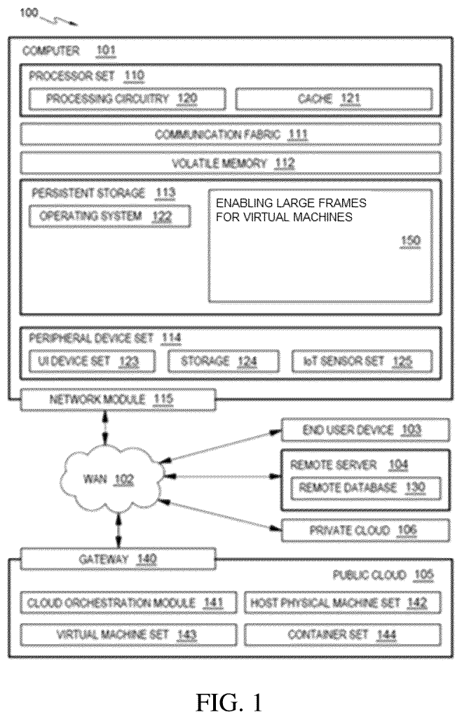

One example of a computing environment to perform, incorporate and/or use one or more aspects of the present disclosure is described with reference to FIG. 1. In one example, a computing environment 100 contains an example of an environment for the execution of at least some of the computer code involved in performing the inventive methods, such as enabling large frames for secure VMs 150 (also referred to herein as block 150). In addition to block 150, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 150, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

Computer 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

Processor set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer-readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer-readable program instructions are stored in various types of computer-readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 150 in persistent storage 113.

Communication fabric 111 is the signal conduction path that allows the various components of computer 101 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 150 typically includes at least some of the computer code involved in performing the inventive methods.

Peripheral device set 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made though local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer-readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 103 is any computer system that is used and controlled by an end user (for example, a customer of an enterprise that operates computer 101) and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

Cloud computing services and/or microservices (not separately shown in FIG. 1): private and public clouds 106, 105 are programmed and configured to deliver cloud computing services and/or microservices (unless otherwise indicated, the word “microservices” shall be interpreted as inclusive of larger “services” regardless of size). Cloud services are infrastructure, platforms, or software that are typically hosted by third-party providers and made available to users through the internet. Cloud services facilitate the flow of user data from front-end clients (for example, user-side servers, tablets, desktops, laptops), through the internet, to the provider's systems, and back. In some embodiments, cloud services may be configured and orchestrated according to as “as a service” technology paradigm where something is being presented to an internal or external customer in the form of a cloud computing service. As-a-Service offerings typically provide endpoints with which various customers interface. These endpoints are typically based on a set of APIs. One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (SaaS) where software is centrally hosted and allocated on a subscription basis. SaaS is also known as on-demand software, web-based software, or web-hosted software. Four technological sub-fields involved in cloud services are: deployment, integration, on demand, and virtual private networks.

The computing environment described above is only one example of a computing environment to incorporate, perform and/or use one or more aspects of the present disclosure. Other examples are possible. For instance, in one or more embodiments, one or more of the components/modules/blocks of FIG. 1 are not included in the computing environment and/or are not used for one or more aspects of the present disclosure. Further, in one or more embodiments, additional and/or other components/modules/blocks may be used. Other variations are possible.

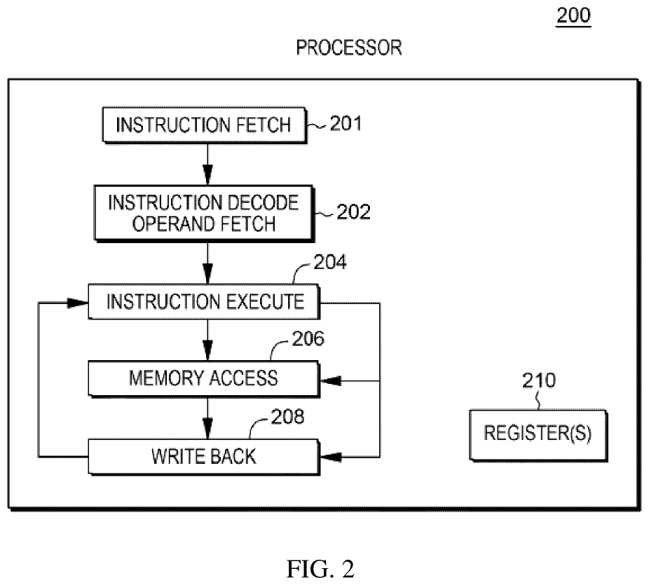

In one example, a processor (e.g., of processor set 110) includes a plurality of functional components (or a subset thereof) used to execute instructions. As depicted in FIG. 2, in one example, a processor 200 includes, for instance, an instruction fetch component 201 to fetch instructions to be executed; an instruction decode/operand fetch component 202 to decode the fetched instructions and to obtain operands of the decoded instructions; one or more instruction execute components 204 to execute the decoded instructions; a memory access component 206 to access memory for instruction execution, if necessary; and a write back component 208 to provide the results of the executed instructions. One or more of the components may access and/or use one or more registers 210 in instruction processing. Further, one or more of the components may access and/or use processing code to generate and return an instruction's firmware code level 150. Additionally, fewer, and/or other components may be used in one or more aspects of the present disclosure.

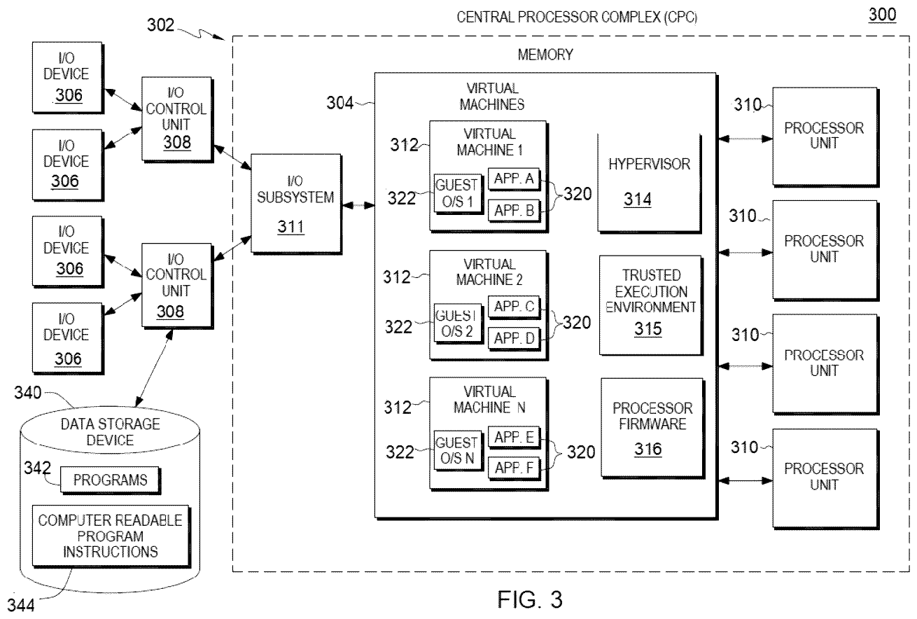

One embodiment of a computing environment to incorporate and use one or more aspects of the present invention is described with reference to FIG. 3. This computing environment was selected for inclusion based on the depictions of virtual machines as part of the technical architecture. As an example, this computing environment can be based on the z/Architecture® instruction set architecture, offered by International Business Machines Corporation, Armonk, New York.

Referring to FIG. 3, in one example, a computing environment 300 includes a central processor complex (CPC) 302. Central processor complex 302 is, for instance, an IBM Z® server (or other server or machine offered by International Business Machines Corporation or other entities) and includes a plurality of components, such as, for instance, a memory 304 (a.k.a., system memory, main memory, main storage, central storage, storage) coupled to one or more processor units (also referred to as processors) 310 and to an input/output (I/O) subsystem 311. Example processor units 310 include one or more general-purpose processors (a.k.a., central processors or central processing units (CPUs)) and/or one or more other processors. IBM Z is a trademark or registered trademark of International Business Machines Corporation in at least one jurisdiction.

I/O subsystem 311 can be a part of the central processor complex or separate therefrom. It directs the flow of information between main storage 304 and input/output control units 308 and input/output (I/O) devices 306 coupled to the central processor complex.

Many types of I/O devices may be used. One particular type is a data storage device 340. Data storage device 340 can store one or more programs 342, one or more computer readable program instructions 344, and/or data, etc. The computer readable program instructions can be configured to carry out functions of embodiments of aspects of the invention.

Central processor complex 302 can include and/or be coupled to removable/non-removable, volatile/non-volatile computer system storage media. For example, it can include and/or be coupled to a non-removable, non-volatile magnetic media (typically called a “hard drive”), a magnetic disk drive for reading from and writing to a removable, non-volatile magnetic disk (e.g., a “floppy disk”), and/or an optical disk drive for reading from or writing to a removable, non-volatile optical disk, such as a CD-ROM, DVD-ROM or other optical media. It should be understood that other hardware and/or software components could be used in conjunction with central processor complex 302. Examples include, but are not limited to: microcode or millicode, device drivers, redundant processing units, external disk drive arrays, RAID systems, tape drives, and data archival storage systems, etc.

Further, central processor complex 302 can be operational with numerous other general-purpose or special-purpose computing system environments or configurations. Examples of well-known computing systems, environments, and/or configurations that may be suitable for use with central processor complex 302 include, but are not limited to, personal computer (PC) systems, server computer systems, thin clients, thick clients, handheld or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Central processor complex 302 provides, in one or more embodiments, virtualization support, in which memory 304 includes, for example, one or more virtual machines 312 (also referred to as guests), a virtual machine manager, such as a hypervisor 314, that manages the virtual machines, a trusted execution environment 315 (also referred to as an Ultravisor) and processor firmware 316. One example of hypervisor 314 is the z/VM® hypervisor, offered by International Business Machines Corporation, Armonk, New York. The hypervisor is sometimes referred to as a host. z/VM is a trademark or registered trademark of International Business Machines Corporation in at least one jurisdiction.

In one or more embodiments, trusted execution environment 315 may be implemented, at least in part, in hardware and/or firmware configured to perform, for instance, processes such as described herein. The trusted execution environment is trusted firmware and/or hardware that makes use of memory-protection hardware to enforce memory protection. The owner of a guest can securely pass information (using, e.g., IBM Secure Execution) to the trusted execution environment by using a public host key, which is embedded in a host key document. To process the confidential information, the trusted execution environment uses a matching private host key. The private host key is specific to the server, e.g., the IBM Z® server, and is hardware protected.

Processor firmware 316 includes, e.g., the microcode or millicode of a processor. It includes, for instance, the hardware-level instructions and/or data structures used in implementation of higher-level machine code. In one embodiment, it includes, for instance, proprietary code that is typically delivered as microcode or millicode that includes trusted software, microcode or millicode specific to the underlying hardware and controls operating system access to the system hardware.

The virtual machine support of the central processor complex provides the ability to operate large numbers of virtual machines 312, each capable of operating with different programs 320 and running a guest operating system 122, such as the Linux® operating system. Each virtual machine 312 is capable of functioning as a separate system. That is, each virtual machine can be independently reset, run a guest operating system, and operate with different programs. An operating system or application program running in a virtual machine appears to have access to a full and complete system, but in reality, only a portion of it is available. Although z/VM and Linux are offered as examples, other virtual machine managers and/or operating systems may be used in accordance with one or more aspects of the present invention. The registered trademark Linux® is used pursuant to a sublicense from the Linux Foundation, the exclusive licensee of Linus Torvalds, owner of the mark on a worldwide basis.

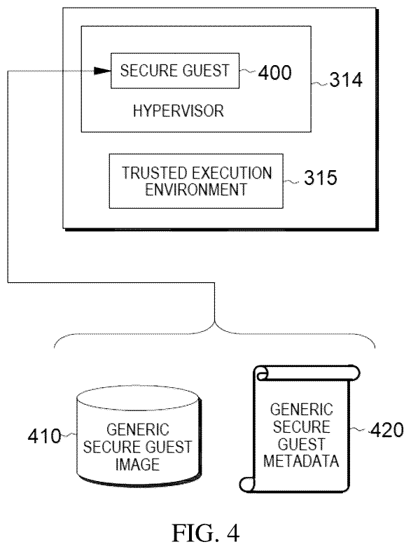

In one embodiment, one or more guests 312 are secure guests. Referring to FIG. 4, a secure guest 400 is started by a hypervisor (e.g., hypervisor 314) in a manner that the hypervisor cannot observe the state (e.g., memory, registers, etc.) of the secure guest. For instance, in one embodiment of confidential computing, the hypervisor can start/stop a secure guest, and the hypervisor knows where data used to start the secure guest is located but it cannot look into the running secure guest. Data used to load/start the secure guest may be encrypted in a manner that the hypervisor cannot see the secure guest. The owner of the secure guest image places confidential data in the secure guest metadata and then generates a secure guest image together with the secure guest metadata. After the secure guest is loaded, any interaction with the state of the secure guest is processed by a trusted execution environment, such as trusted execution environment 315.

In one embodiment, to start a secure guest, the hypervisor passes a secure guest image 410 that the hypervisor previously loaded into memory and secure guest metadata 420 to trusted execution environment 315. The metadata is integrity and at least partially confidentially protected and is only interpreted by the trusted execution environment. Based on the information in the secure guest metadata, the trusted execution environment can then enforce the integrity of the secure guest image loaded into memory, protect the memory of the secure guest containing the loaded image from being accessible by the hypervisor, and potentially decrypt the secure guest image before starting the secure guest.

In the examples herein, secure guests, also referred to as secure execution guests, run virtualized under a hypervisor (e.g., a kernel virtual machine (KVM) hypervisor, which is part of a Linux kernel). The KVM hypervisor is a non-limiting example of a hypervisor or host that can be utilized in the examples herein. The hypervisor (e.g., host) can page out guest memory at any time. The hypervisor is untrusted while a secure interface control, which can be an Ultravisor (UV) is a secure entity (e.g., hardware and/or milicode) and enforces security properties of the secure guests.

FIG. 5 is a technical environment 500 that can include various aspects of some embodiments of the present disclosure. The components that comprise the technical environment 500 of FIG. 5 illustrate how a secure interface control enables a guest owner to control functionality of a guest image, via encryption unique to each owner, and the secure interface control enables/disables a secure guest, based on a given image, to execute in particular host environments. In this example, for Secure Execution, a secure guest 510 is cryptographically linked to metadata 540, which is securely communicated to a secure interface control 530 (e.g., trusted firmware, trusted component, etc.), based on a private host key which is accessible to the secure interface control 530, only. The owner of the secure guest 510 controls the secure interface control 530 allowing or prohibiting execution of the secure guest 510, based on environmental constraints imposed by the owner. For example, the environmental constraints imposed by the owner, through the secure interface control 530, could limit execution of a secure guest in a host system configured to do hardware measurements and/or on a host system configured to use a non-system specific host key. In some embodiments of the present invention, the key to encrypt portions of the metadata is derived using a private key that is only accessible to the secure interface control 530. The secure interface control 530 can also monitor the system settings 570 during runtime, so that the secure interface control 530 can cause the hypervisor 520 to terminate the secure guest 510, if and when the system settings 570 change such that the controls 560 no longer indicate that the secure guest 510 is compatible with the technical environment 500.

As noted above, a secure guest 510 (e.g., virtual machine, virtual server) is controlled by a hypervisor 520 (e.g., virtual machine manager). The secure interface control 550 can obtain, from an owner of the secure guest 510, via the hypervisor 520, metadata associated with the secure guest 540. In some embodiments of the present invention, the metadata 540 is cryptographically linked to the boot image of the secure guest 510. The metadata 540 need not be accessible to the secure guest 510, itself. The metadata 540 can be linked to the image of the secure guest 510. In some embodiments of the present invention, the metadata 540 is cryptographically linked to a guest (e.g., contains a signature of the guest image) so metadata of one guest cannot be misused as metadata of another guest. The metadata 540 can be transferred (e.g., independently, through a secure channel) to the secure interface control 530 such that it is integrity and confidentiality protected.

The examples herein include computer-implemented methods, computer program products, and computer systems that enable a secure interface control to back a secure guest with a large page or frame in a manner that is in keeping with the security protocols and guarantees of secure execution. Maintaining the processing efficiencies and security of the computing environment while enabling this functionality includes checking that certain properties are present before enabling a secure guest to utilize a large frame or page. First, the secure interface control 530 determines that the small pages in the large frame which the hypervisor or host will utilize to back the secure guest is imported (e.g., in secure memory) and that all the small pages belong to the same guest. A large frame is comprised of smaller frames, for example, a large frame, which can be 1M (or smaller or larger than 1M), and can be comprised of multiple smaller (e.g., 4k) pages. The size of the large pages just needs to exceed that of the smaller pages so that smaller pages can comprise a larger page. All the small pages belong to the same guest when there are no holes in the pages (meaning that the ownership is consistent across the whole page or frame) so there can be no cross communication between secure guests. Second, all these small pages that comprise the host large frame (which is to be used to back a secure guest) are mapped from one single large guest frame. The pages are not spliced from different large frames as this could create both security and processing challenges. Third, the small pages that comprise the large frame have the same offset in the guest and in the host so that there is no shuffling of guest pages in the large frames. The presence of these three properties enables secure execution of the secure guest and if any of these properties does not exist in a large frame to be assigned to secure guest, the security guarantees of secure execution would be violated so that large frame cannot be used to back a secure guest.

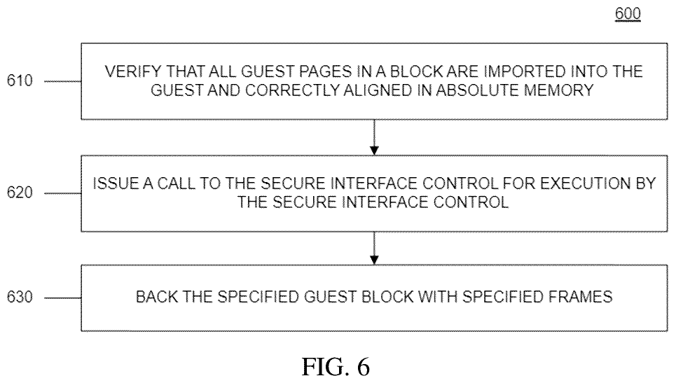

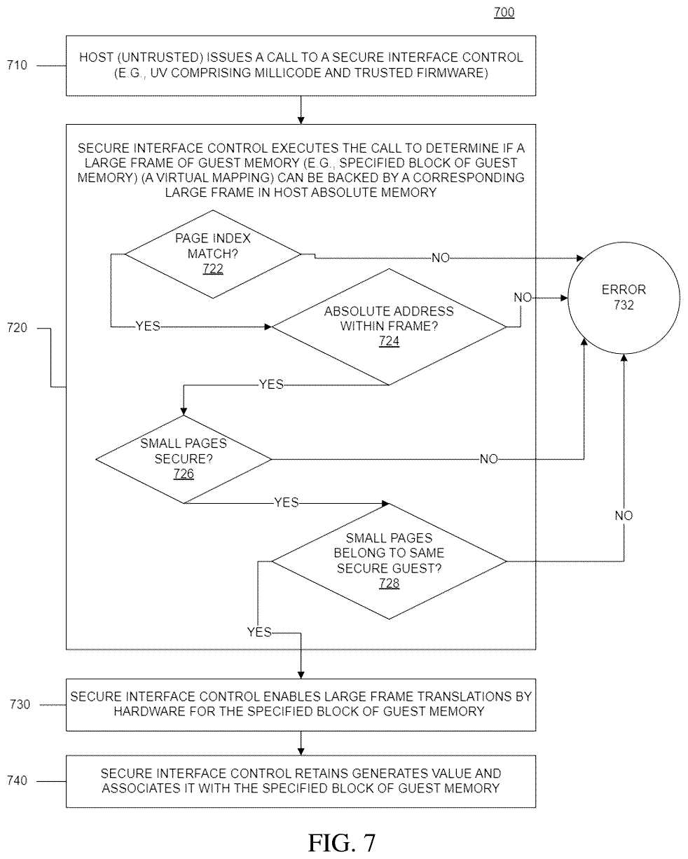

As discussed earlier, enabling the backing of a secure guest with a large frame includes: 1) introducing a new interface between the host (hypervisor) and the firmware and/or hardware of the secure interface control; and 2) modifying a secure guest mapping table to include a bit (e.g., 1M bit or smaller or larger), that indicates that a secure guest can be backed with a larger page and/or frame. The call triggers the secure interface control 530 to determine whether the properties exist and the bit in the table can indicate to the secure interface control 530 that these properties were satisfied. FIGS. 6 and 7 provide workflows 600 700 that include certain of these aspects. FIG. 6 provide a general overview while FIG. 7 provides more detail related to the call (interface) and the table modification. Changing a value in a table is an example of one implementation, however, when frames are cleared for use by a secure interface control (e.g., UV), this can be memorialized in other parts of the system, for example by updating or adding a bit in a bitmap.

Referring to FIG. 6, in this workflow 600, backing a secure guest with a large frame includes verifying that all guest pages in the block (which will be backed by the host) are imported into the guest and correctly aligned in absolute memory (610). A requestor (e.g., the hypervisor), issues a call to the secure interface control (e.g., the UV) which is executed by the secure interface control (620). This call is an interface between the hypervisor (untrusted) and the secure interface control (secure) and can be referred to as a UV call or a UVC. The specific call, in some examples, is Verify Large Frames. Attempting to utilize a large frame mapping without successfully issuing the call can result in a program interrupt in the host. Once the call is issued successfully, the hypervisor can back the specified guest block with the specified frames, e.g., frames can be used for the specified guest block (630). As will be discussed herein, small frames can still be used but this workflow 600 can enable the use of large frames for secure guests.

FIG. 7 is a workflow 700 that includes the call as well as writing to a table (or a bitmap) to indicate the availability of a large frame (and the small pages that comprise it) for backing a secure guest in a computing system. Referring to FIG. 7, in this workflow 700, a host (untrusted) issues a call (e.g., Verify Large Frame UVC) to a secure interface control (e.g., a UV comprising millicode and trusted firmware) (710). Based on obtaining the call, the secure interface control executes the call to determine if a large frame of guest memory (e.g., specified block of guest memory) (a virtual mapping) can be backed by a corresponding large frame in host absolute memory (720). To make this determination, the secure interface control checks that a page index field of the virtual address of the large of guest memory frame matches with a page index field of the corresponding absolute address in the host absolute memory (722). The secure interface control also checks that absolute addresses of the small pages comprising the frame lie within the large frame in absolute memory (724). The secure interface control also checks each small page is secure (726) and that each small page belongs to the same secure guest (e.g., VM) (728). These checks are illustrated in FIG. 7 in a given order as an example and can be performed in different orders and/or one or all can be performed synchronously. If any of the conditions (checks) fail, there is an error (732). If these checks are successful, the secure interface control enables large frame translations by hardware for the specified block of guest memory (730). To enable this translation, the secure interface control generates a value and associates it with this specified block of guest memory (740). For example, the secure interface control can set a bit in a bitmap. Alternatively or additionally, the secure interface control can make an entry an a table, such as the SEIDT, for either a first block on the large frame or for all blocks of the large frame (as in this examples although a large frame can be allocated to a secure guest, the small frames comprising this frame can also be allocated).

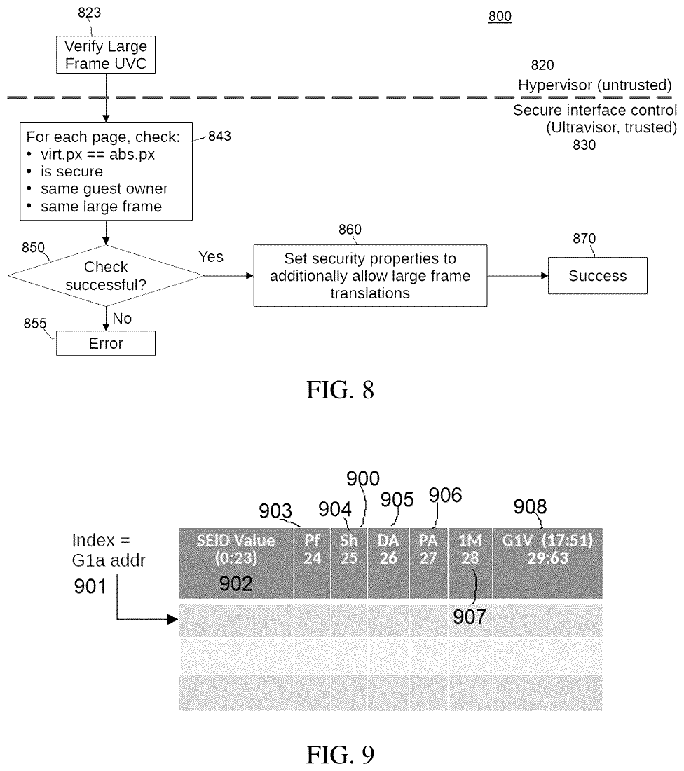

FIG. 8 further illustrates a workflow 800 of the call interface between the untrusted host (hypervisor) in the context of the computing environment which includes a hypervisor 820 and a secure interface control 830. The hypervisor 820 makes a call (e.g., Verify Large Frame UVC 823) to the secure interface control 830, which will execute the call. The secure interface control 830 performs the checks 843 discussed in FIG. 7, for each page, checking is the virtual and absolute page indexes match (virt.px==abs.px), if the pages are secure, if the small pages comprising the large page are owned by the same secure guest, and if the small pages belong to the same large frame. The secure interface control 830 determines if the checks were successful (850). If they were not successful, the secure interface control 830 can return an error (855). If the check were successful, the secure interface control 830 sets security properties to additionally allow large frame translations (860). Hence, the call was successful (870).

An option for designating that large frame translations are enabled for a secure guest is setting a value in a table or a bitmap. A non-limiting example of a table where this information can be stored and can be referenced by a secure interface control is the SEID table or SEIDT. FIG. 9 depicts an example of the SEIDT which was modified to indicate when a small page is part of a large frame and that a given page can be allocated to a secure guest.

Referring to FIG. 9, the SEID table 900 includes an applicable table entry for G1 absolute addresses (Index=G1a addr 901). The SEID table only applies to secure accesses. SEID value 902 identifies which G2 configuration or UV storage. Pf 903 is a prefix map bit that indicates that this page is high availability (HA) for a guest prefix page. Computing environments often have a select area of memory to be used by the machine or programs to communicate with the operating system. This area of memory may be referred to as prefix pages. The memory is defined as real memory and dynamic translation is not required for access. These pages contain a series of predefined assigned storage locations. Each virtual processor within the operating system configuration has a unique prefix value. This prefix value maps the assigned real storage location to an absolute address which is used only by that processor. The pages of memory can be explicitly or implicitly accessed during the execution of a program. Explicit access occurs due to execution of certain instructions, like a Supervisor Call or Store Facility List instruction defined, for instance, in the z/Architecture® instruction set architecture offered by International Business Machines Corporation. Implicit access occurs due to conditions outside the scope of instruction execution, and includes, for instance, architected interrupts, such as machine checks, external interrupts, input/output (I/O) interrupts, etc., or program interrupts encountered during execution of instructions, as a side affect of stores, or due to an abnormal termination of a transaction. The DA 905 (Disable Address-compare) bit disables the GIV check. PA 906 is the primary address of the Primary Address-Space-Control Element (PASCE). This small page (e.g., 4k page, but the size can vary) is used as GIPASCE for a secure configuration. The IM 907 field indicates that the 4k page is part of a IM frame. The values 1M and 4k are provided as examples only and not to suggest any limitations. In this examples, 1M is used for illustrative purposes as a field with a configured large page value, which can be larger than 1M. G1 virtual address (GIV 908) maps to this GIA address in the SEID table. In this example, the SEID table is not referenced when a translation lookside buffer (TLB) hit is performed. In some computing environments, the SEID table or wherever the value is saved after the checks are performed can be set in hardware.

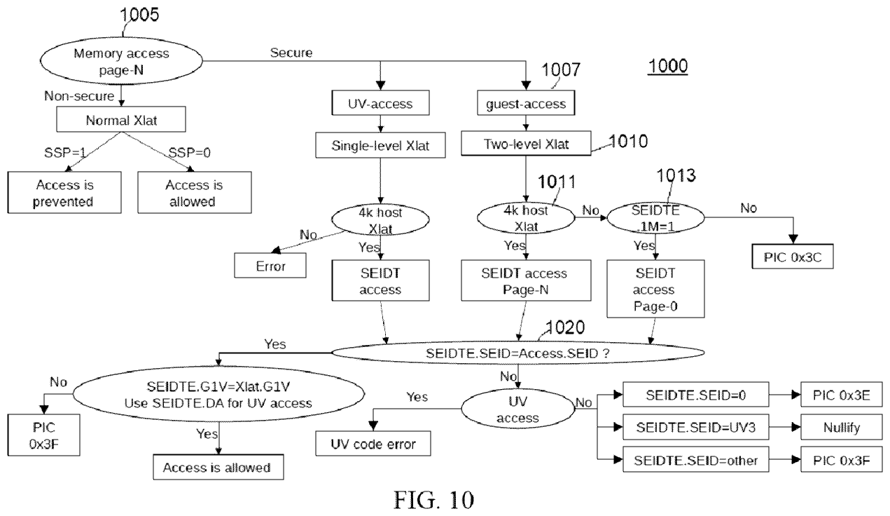

FIG. 10 is a workflow 1000 that contextualizes the memory accesses discussed herein in the context of secure and non-secure guest management in a computing environment. For illustrative purposes only and not to suggest any limitations, certain specific elements are referenced herein. Only certain parts of this workflow, which are relevant to the present disclosure, will be reviewed. In the workflow 1000, secure execution utilizing host memory 1005 by a secure guest 1007 is desired. After a two-level translation 1010, the access is differentiated as either a small page access (4k host translation 1011) or an access is sought to a large frame, referencing the SEID table (SEIDTE 1M=1 1013), as the table is checked for the large page size designation bit (e.g., 1M bit in this example but can be larger) to see if the secure guest can be backed by a large frame. Beyond a designation in a table or a bitmap, there can be other security rules or factors that can affect the decision of a secure interface control to enable a hypervisor to back a secure guest with a large frame. However, the memory access determinations described herein are depicted in FIG. 10.

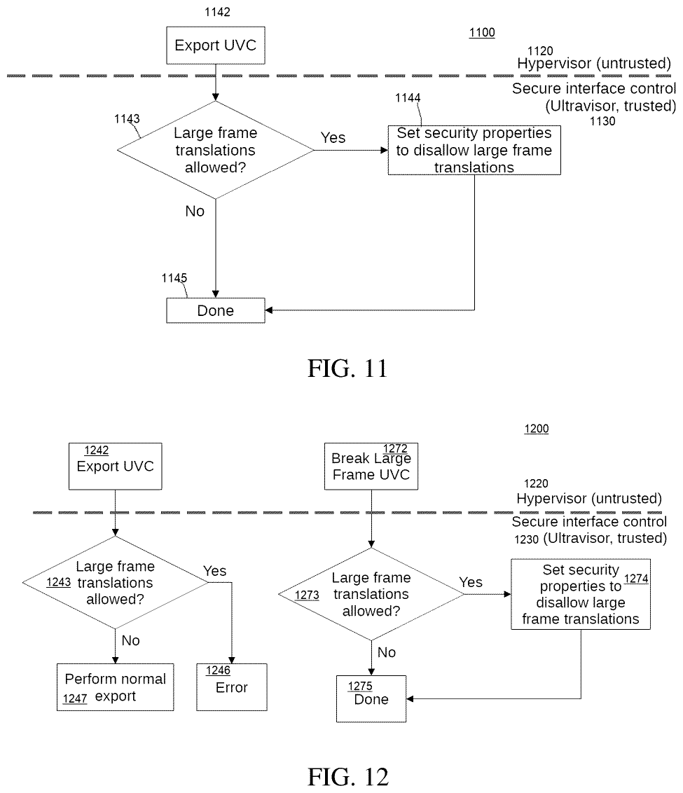

In some examples herein, the host (hypervisor) can break (break up) a large frame that was formerly available to back a secure guest. Depending on the security settings, in a computing environment, a host may not have permissions to change the security properties of a small frame that belongs to a verified large frame without the assistance of the secure interface control. Thus, while FIG. 11 illustrates a workflow 1100 in which a host has permissions to break a large frame, FIG. 12 illustrates a workflow 1200 in which the host does not have these permissions. In both examples, the host uses a call (e.g., UVC) to enable the security interface control 1130 to execute to break a frame.

Referring to FIG. 11, in this workflow 1100, the hypervisor 1120 has access to change security properties (e.g., permissions) of a small frame belonging to a verified large frame (a frame that could be utilized to back secure guests). To that end, the hypervisor 1120 can export a page (e.g., a small page (4k) of those belonging to the verified large frame). As a result, the host large frame cannot be used anymore to back the large (e.g., 1M or smaller or larger) guest frame and only small frames would be allowed for translating the large frame of guest memory. FIG. 11 depicts the hypervisor 1120 making a call (1142) to the secure interface control 1130 to export a page from a large frame for which translations are allowed (1143). When the export call was make to a large frame for which translations are allowed, the secure interface control 130 executes the call to enable the export and the host can sets security properties to disallow large frame translations (because the small page was exported, the properties to enable large frame translations are no longer met) (1144). The process is then complete (1145). If the hypervisor 1120 did not export from a large frame for which translation were allowed, then there are no changes to security settings and the process is also complete (1145).

Referring to FIG. 12, when the host (hypervisor 1220) is not allowed to change the security properties of memory belonging to a large, verified frame, the hypervisor 1220 issues a call. This call can be a new call (e.g., UVC) and can be referred to as Break Large Frames. In this way, the hypervisor 1120 can interface with the security interface control 1230. FIG. 12 depicts that the hypervisor 1220, when using an export call 1142 cannot set security properties as instead, if large frame translations are allowed (1243) in the frame from which the hypervisor seeks to export a page, there is an error (1246). If large frame translations are not allowed (1243), then a normal export can proceed (1247). Hence, the break the frame, the hypervisor 1220 uses a different call (e.g., Break Large Frame UVC 1272) to the secure interface control 1230. The secure interface control 1230 executes the call and checks if large frame translations are allowed for the large frame targeted by the call (1273). If large frame translations are not allowed, the process is complete (1275) as no security settings will change. However, if the large frame translations are allowed for the large frame targeted in the call, the secure interface control 1230 sets the security properties to disallow large frame translations (1274). When the security settings are changed, the large frame cannot be used anymore for backing the specified (in the call) large (e.g., 1M or smaller or larger) frame of secure guest memory. Instead, only small frames are allowed in the host for backing the specified large (e.g., 1M or smaller or larger) frame of secure guest memory. Additionally, the host can now change the security properties of memory that belonged to the verified large frame. The host can change the security property of a small frame belonging to a verified large frame, for example by exporting one page (e.g., paging out guest memory).

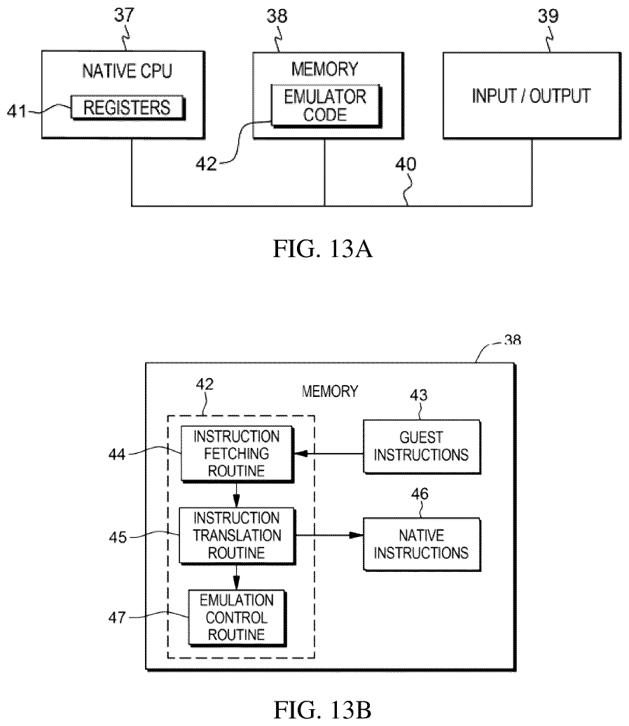

Although one or more examples of a computing environment to incorporate and use one or more aspects of the present disclosure are described herein, FIGS. 13A-13B depict another embodiment of a computing environment to incorporate and use one or more aspects of the present disclosure.

Referring, initially, to FIG. 13A, in this example, a computing environment 36 includes, for instance, a native central processing unit (CPU) 37 based on one architecture having one instruction set architecture, a memory 38, and one or more input/output devices and/or interfaces 39 coupled to one another via, for example, one or more buses 40 and/or other connections.

Native central processing unit 37 includes one or more native registers 41, such as one or more general purpose registers and/or one or more special purpose registers used during processing within the environment. These registers include information that represents the state of the environment at any particular point in time.

Moreover, native central processing unit 37 executes instructions and code that are stored in memory 38. In one particular example, the central processing unit executes emulator code 42 stored in memory 38. This code enables the computing environment configured in one architecture to emulate another architecture (different from the one architecture) and to execute software and instructions developed based on the other architecture.

Further details relating to emulator code 42 are described with reference to FIG. 13B. Guest instructions 43 stored in memory 38 comprise software instructions (e.g., correlating to machine instructions) that were developed to be executed in an architecture other than that of native CPU 37. For example, guest instructions 43 may have been designed to execute on a processor based on the other instruction set architecture, but instead, are being emulated on native central processing unit 37, which may be, for example, the one instruction set architecture. In one example, emulator code 42 includes an instruction fetching routine 44 to obtain one or more guest instructions 43 from memory 38, and to optionally provide local buffering for the instructions obtained. It also includes an instruction translation routine 45 to determine the type of guest instruction that has been obtained and to translate the guest instruction into one or more corresponding native instructions 46. This translation includes, for instance, identifying the function to be performed by the guest instruction and choosing the native instruction(s) to perform that function.

Further, emulator code 42 includes an emulation control routine 47 to cause the native instructions to be executed. Emulation control routine 47 may cause native central processing unit 37 to execute a routine of native instructions that emulate one or more previously obtained guest instructions and, at the conclusion of such execution, return control to the instruction fetch routine to emulate the obtaining of the next guest instruction or a group of guest instructions. Execution of the native instructions 46 may include loading data into a register from memory 38; storing data back to memory from a register; or performing some type of arithmetic or logic operation, as determined by the translation routine.

Each routine is, for instance, implemented in software, which is stored in memory and executed by native central processing unit 37. In other examples, one or more of the routines or operations are implemented in firmware, hardware, software or some combination thereof. The registers of the emulated processor may be emulated using registers 41 of the native central processing unit or by using locations in memory 38. In embodiments, guest instructions 43, native instructions 46 and emulator code 42 may reside in the same memory or may be disbursed among different memory devices.

An example instruction that may be emulated is a call from a host to a secure interface control, such as those discussed herein, in accordance with one or more aspects of the present disclosure. Other instructions are also possible.

The computing environments described herein are only examples of computing environments that can be used. One or more aspects of the present disclosure may be used with many types of environments. The computing environments provided herein are only examples. Each computing environment is capable of being configured to include one or more aspects of the present disclosure. For instance, each may be configured to implement control mode processing and/or to perform one or more other aspects of the present disclosure. Software and hardware performance is improved by eliminating extra code and executing time and preventing errors (e.g., for not initializing the unused fields with zeros).

In addition to the above, one or more aspects may be provided, offered, deployed, managed, serviced, etc. by a service provider who offers management of customer environments. For instance, the service provider can create, maintain, support, etc. computer code and/or a computer infrastructure that performs one or more aspects for one or more customers. In return, the service provider may receive payment from the customer under a subscription and/or fee agreement, as examples. Additionally, or alternatively, the service provider may receive payment from the sale of advertising content to one or more third parties.

In one aspect, an application may be deployed for performing one or more embodiments. As one example, the deploying of an application comprises providing computer infrastructure operable to perform one or more embodiments.

As a further aspect, a computing infrastructure may be deployed comprising integrating computer-readable code into a computing system, in which the code in combination with the computing system is capable of performing one or more embodiments.

Yet a further aspect, a process for integrating computing infrastructure comprising integrating computer-readable code into a computer system may be provided. The computer system comprises a computer-readable medium, in which the computer medium comprises one or more embodiments. The code in combination with the computer system is capable of performing one or more embodiments.

Various aspects and embodiments are described herein. Further, many variations are possible without departing from a spirit of aspects of the present disclosure. It should be noted that, unless otherwise inconsistent, each aspect or feature described and/or claimed herein, and variants thereof, may be combinable with any other aspect or feature.

The terminology used herein is for the purpose of describing particular embodiments only and is not intended to be limiting. As used herein, the singular forms “a”, “an” and “the” are intended to include the plural forms as well, unless the context clearly indicates otherwise. It will be further understood that the terms “comprises” and/or “comprising”, when used in this specification, specify the presence of stated features, integers, steps, operations, elements, and/or components, but do not preclude the presence or addition of one or more other features, integers, steps, operations, elements, components and/or groups thereof.

The corresponding structures, materials, acts, and equivalents of all means or step plus function elements in the claims below, if any, are intended to include any structure, material, or act for performing the function in combination with other claimed elements as specifically claimed. The description of one or more embodiments has been presented for purposes of illustration and description but is not intended to be exhaustive or limited to in the form disclosed. Many modifications and variations will be apparent to those of ordinary skill in the art. The embodiment was chosen and described in order to best explain various aspects and the practical application, and to enable others of ordinary skill in the art to understand various embodiments with various modifications as are suited to the particular use contemplated.

What is claimed is:

1. A computer program product comprising:
a set of one or more computer-readable storage media; and
program instructions, collectively stored in the set of one or more computer-readable storage media, for causing at least one computing device to perform computer operations including:
executing, in a trusted computing environment, a call from a host in an untrusted computing environment, wherein the call is to determine a status of a large page of memory for use by a secure guest, wherein the secure guest is managed by the host in the untrusted computing environment, wherein the executing comprises:
determining that all small pages comprising the large page and the large page meet pre-defined security requirements;
based on the determining, setting security properties of the large page and the small pages comprising the large page to enable translation for the large page for a given block of memory of the secure guest; and
storing in a computing element, a designation identifying the large page as belonging to the secure guest.

2. The computer program product of claim 1, wherein the secure guest comprises a virtual machine.

3. The computer program product of claim 1, wherein the host comprises a hypervisor.

4. The computer program product of claim 1, wherein the computing element is selected from the group consisting of: a bitmap and a table.

5. The computer program product of claim 1, wherein the translation for the large page for the given block of memory of the secure guest is performed by hardware in trusted computing environment.

6. The computer program product of claim 1, wherein determining that all small pages comprising the large page and the large page meet pre-defined security requirements comprises:
for each page of the small pages and the large page:
determining that a page index field of a virtual address matches a page index field of a corresponding absolute address;
determining that the page is secure;
determining that the page has the same guest owner as all other pages of the small pages and the large page; and
determining that an absolute address of the page is located within a common large page in absolute memory.

7. The computer program product of claim 1, the computer operations further comprising:
receiving a request from the host to back the secure guest with the large page; and
providing the host with access to the large page.

8. The computer program product of claim 1, wherein the executing is performed by a secure interface control in the trusted computing environment.

9. The computer program product of claim 1, the computer operations further comprising:
obtaining a request from the host to export a small page of the small pages comprising the large page; and
determining that the host has permission to perform the export, wherein based on the export, the security properties are re-set to disallow translation for the large page.

10. The computer program product of claim 1, the computer operations further comprising:
obtaining a request from the host to export a small page of the small pages comprising the large page; and
based on determining that the host does not have permission to perform the export, generating an error.

11. The computer program product of claim 1, the computer operations further comprising:
executing, in the trusted computing environment, another call from the host, wherein the executing comprises:
re-setting the security properties to disallow translation for the large page.

12. The computer program product of claim 8, wherein the secure interface control comprises elements selected from the group consisting of: millicode and firmware.

13. The computer program product of claim 1, the computer operations further comprising:
receiving a request from the host to back the secure guest with the large page; and
providing the host with access to a small page comprising the large page.

14. A computer system comprising:
at least one computing device;
a set of one or more computer-readable storage media; and
program instructions, collectively stored in the set of one or more computer-readable storage media, for causing the at least one computing device to perform computer operations including:
executing, in a trusted computing environment of the computer system, a call from a host in an untrusted computing environment of the computer system, wherein the call is to determine a status of a large page of memory for use by a secure guest, wherein the secure guest is managed by the host in the untrusted computing environment, wherein the executing comprises:
determining that all small pages comprising the large page and the large page meet pre-defined security requirements;
based on the determining, setting security properties of the large page and the small pages comprising the large page to enable translation for the large page for a given block of memory of the secure guest; and
storing in a computing element, a designation identifying the large page as belonging to the secure guest.

15. The computer system of claim 14, wherein the secure guest comprises a virtual machine.

16. The computer system of claim 14, wherein the host comprises a hypervisor.

17. The computer system of claim 14, wherein the computing element is selected from the group consisting of: a bitmap and a table.

18. The computer system of claim 14, wherein the translation for the large page for the given block of memory of the secure guest is performed by hardware in trusted computing environment.

19. The computer system of claim 14, wherein determining that all small pages comprising the large page and the large page meet pre-defined security requirements comprises:
for each page of the small pages and the large page:
determining that a page index field of a virtual address matches a page index field of a corresponding absolute address;
determining that the page is secure;
determining that the page has the same guest owner as all other pages of the small pages and the large page; and
determining that an absolute address of the page is located within a common large page in absolute memory.

20. The computer system of claim 14, the computer operations further comprising:
receiving a request from the host to back the secure guest with the large page; and
providing the host with access to the large page.

21. A computer-implemented method comprising:
requesting execution of an instruction to perform an action defined by the instruction, wherein the executing the instruction includes:
executing, in a trusted computing environment, a call from a host in an untrusted computing environment, wherein the call is to determine a status of a large page of memory for use by a secure guest, wherein the secure guest is managed by the host in the untrusted computing environment, wherein the executing comprises:
determining that all small pages comprising the large page and the large page meet pre-defined security requirements;
based on the determining, setting security properties of the large page and the small pages comprising the large page to enable translation for the large page for a given block of memory of the secure guest; and
storing in a computing element, a designation identifying the large page as belonging to the secure guest.

22. The computer-implemented method of claim 21, wherein the secure guest comprises a virtual machine.

23. The computer-implemented method of claim 21, wherein the host comprises a hypervisor.

24. The computer-implemented method of claim 21, wherein the computing element is selected from the group consisting of: a bitmap and a table.

25. The computer-implemented method of claim 21, wherein the translation for the large page for the given block of memory of the secure guest is performed by hardware in trusted computing environment.
